(19) United States
(12) Patent Application Publication
(10) Pub. No.: US 2017/0249308 A1
(43) Pub. Date: Aug. 31, 2017

(54) IMAGE TAGGING

(71) Applicant: GrandiOs Technologies, LLC, Charleston, SC (US)

(72) Inventor: John Cronin, Bonita Springs, FL (US)

(21) Appl. No.: 15/412,474

(22) Filed: Jan. 23, 2017

Related U.S. Application Data
(63) Continuation of application No. 14/631,692, filed on Feb. 25, 2015, now abandoned.
(60) Provisional application No. 62/007,873, filed on Jun. 4, 2014.

(51) Int. Cl. G06F 17/30; H04L 29/08; H04L 12/58

(52) U.S. Cl. CPC G06F 17/30038; G06F 17/30581; H04L 51/32; H04L 67/20; G06F 17/30268

(57) ABSTRACT

The present invention allows for image data (photos or video) that include one more identification tags to be shared between different smart devices directly or through a network resource. After an image is acquired by smart device, the image will be tagged with one or more identification tags. In certain instances, the tags identify an entity, an activity, and a location associated with the image. The tags are subsequently used to match tagged images with preferences that may be defined in a contact list, or that may be entered by users of other electronic devices. Tagged images may be shared through a data base located in the Internet, or be shared directly with other smart devices.

### CROSS-REFERENCE TO RELATED APPLICATION

The present application is a continuation and claims the priority benefit of U.S. patent application Ser. No. 14/631,692 filed Feb. 25, 2015, which claims the priority benefit of U.S. provisional application 62/007,873 filed Jun. 4, 2014, the disclosures of which are incorporated herein by reference.

### BACKGROUND OF THE INVENTION

1. Field of the Invention

The field of the invention relates to the identification and sharing of images acquired by an electronic device. More specifically, the invention relates to the sharing of images using one or more identification tags that are associated with an image.

2. Description of the Related Art

Legacy systems exist for acquiring images and tagging those images with tags that identify, describe, or classify the image. In certain instances, these tags may be generated using voice recognition, as typified in U.S. patent application publication 2013/034,068.

These legacy systems, however, do not include systems for sharing tagged images with individuals or systems that use identification tags. Since the sharing of images using 3rd party databases (e.g., FACEBOOK™, INSTAGRAM™) is very popular and allows for ease in searching such images, there is a need for improved systems and methods for image tagging for sharing.

### BRIEF DESCRIPTION OF THE DRAWINGS

FIG. 1 illustrates an exemplary network environment in which a system for image tagging for sharing may be implemented.

FIG. 2 is a flowchart illustrating an exemplary method for image tagging for sharing.

FIG. 3 illustrates exemplary operating system settings of a user device that may be used in a system for image tagging for sharing.

FIG. 4 illustrates an exemplary database that may be used in a system for image tagging for sharing.

FIG. 5 is a flowchart illustrating another exemplary method for image tagging for sharing.

FIG. 6 is a flowchart illustrating yet another exemplary method for image tagging for sharing.

FIG. 7 illustrates a mobile device architecture that may be utilized to implement the various features and processes described herein.

### SUMMARY OF THE CLAIMED INVENTION

Embodiments of the present invention provide systems and methods of image tagging for sharing. Image data (photos or video) that include one more identification tags may be shared between different smart devices directly or through a network resource. After an image is acquired by smart device, the image may be tagged with one or more identification tags. In certain instances, the tags identify an entity, an activity, and a location associated with the image. The tags may subsequently be used to match tagged images with preferences. Such preferences may be defined in a contact list or entered by users of other electronic devices. Tagged images may be shared through a data base located in the Internet or be shared directly with other smart devices.

Various embodiments of the present invention include methods of image tagging for sharing. Such methods may include setting one or more settings through the user interface of an electronic device, acquiring an image by the electronic device, tagging the image with one or more identification tags, and transmitting the tagged image to a remote electronic device identified by the one or more settings.

Additional embodiments of the present invention may be implemented by a system or a non-transitory data storage medium that are configured to implement an embodiment of the invention.

### DETAILED DESCRIPTION

Image data (photos or video) that include one more identification tags may be shared between different smart devices directly or through a network resource. After an image is acquired by smart device, the image may be tagged with one or more identification tags. In certain instances, the tags identify an entity, an activity, and a location associated with the image. The tags may subsequently be used to match tagged images with preferences. Such preferences may be defined in a contact list or entered by users of other electronic devices. Tagged images may be shared through a data base located in the Internet or be shared directly with other smart devices.

Settings input through a user interface of a smart device may then used by a smart device to share or exchange the images with users or resources that have been configured to receive or view those images. When system settings are configured to copy images with their associated identification tags to a picture server, a user device may transmit those images to the picture tag server. Images may also be shared with other databases that exist in the Internet, for example, with a third party database or with a social network database.

Users of the picture tag server, third party database, or social network database may then search for images that match one or more identification tags of an image, and those users may download any matching image. In certain instances, a third part data base may send matched images directly to a plurality of user devices. In other instances, the user of a smart device may transmit images directly to other users in their contact list. Usually, one or more of the settings used to configure the sharing of the tagged images may be implemented in the operating system of a user device.

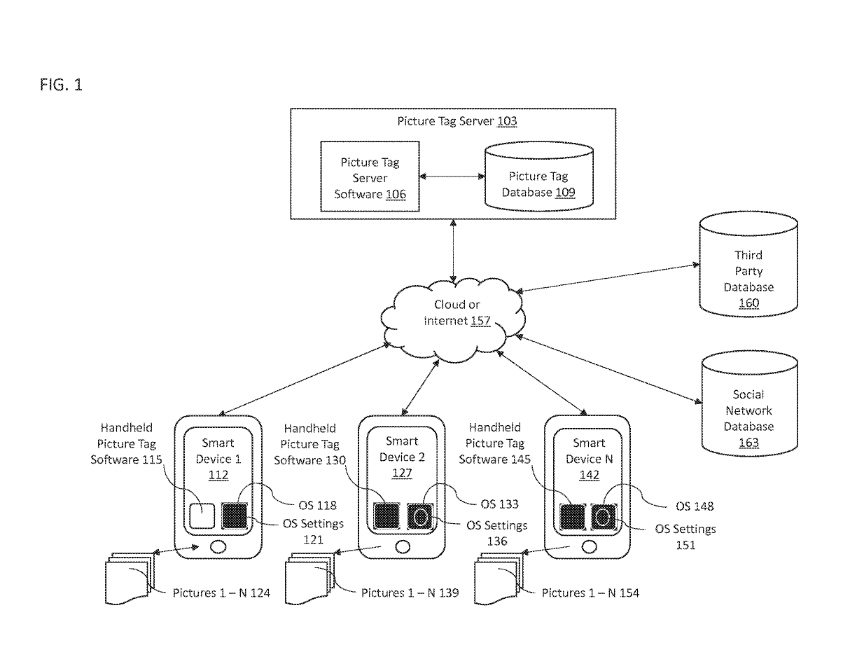

FIG. 1 illustrates an exemplary network environment in which a system for image tagging for sharing may be implemented. As illustrated, the network environment may include a picture tag server 103, smart device 1 112, smart device 2 127, smart device N 142, the cloud communication network 157, third party database 160, and social network database 163.

Picture tag server 103 may include any type of server or other computing device as is known in the art, including standard hardware computing components such as network and media interfaces, non-transitory computer-readable storage (memory), and processors for executing instructions or accessing information that may be stored in memory. The functionalities of multiple servers may be integrated into a single server. Alternatively, different functionalities may be allocated among multiple servers, which may be located remotely from each other and communicate over the cloud. Any of the aforementioned servers (or an integrated server) may take on certain client-side, cache, or proxy server characteristics. These characteristics may depend on the particular network placement of the server or certain configurations of the server. Picture tag server may include picture tag server software 106 and picture tag database 109.

Each smart device 1 112, 2 127, and N 142 may each include corresponding handheld picture tag software, operating system, operating system settings, and pictures. Smart device 1 112 includes handheld picture tag software 115, operating system software 118, OS settings 121, and pictures 1-N 124. Smart device 2 127 includes handheld picture tag software 130, operating system software 133, OS settings 133, and pictures 1-N 136, smart device N 139. Smart device N 142 includes handheld picture tag software 145, operating system software 148, OS settings 151, and pictures 1-N 136, smart device N 154.

Users may use any number of different electronic smart devices 112, 127, 142, such as general purpose computers, mobile phones, smartphones, personal digital assistants (PDAs), portable computing devices (e.g., laptop, netbook, tablets), desktop computing devices, handheld computing device, or any other type of computing device capable of communicating over communication network 157. User devices may also be configured to access data from other storage media, such as memory cards or disk drives as may be appropriate in the case of downloaded services. User device may include standard hardware computing components such as network and media interfaces, non-transitory computer-readable storage (memory), and processors for executing instructions that may be stored in memory.

The handheld picture tag software in each of the smart devices uses operating system settings in the operating system OS of each smart device to organize and share image data with other smart devices with the picture tag server 103, the third party database 160, and the social network database 163.

Operating system (OS) is a collection of software that manages computer hardware resources and provides common services for computer programs, including handheld picture tag software. The operating system is an essential component of the system software in a computer system. The handheld picture tag software may be developed for a specific operation system and therefore rely on the associated operating system to perform its functions. For hardware functions such as input and output and memory allocation, the operating system acts as an intermediary between handheld picture tag software and the computer hardware. Although application code is usually executed directly by the hardware, handheld picture tag software may make a system call to an OS function or be interrupted by it. Operating systems can be found on almost any device with computing or processing ability. Examples of popular modern operating systems include Android, BSD, iOS, Linux, OS X, QNX, Microsoft Windows, Windows Phone, and IBM z/OS. Most of these (except Windows, Windows Phone and z/OS) may share roots in UNIX.

Operating system settings may be a software function that opens a display that lists OS functions that may be generated upon selection of a user interface button. Such a list of OS functions may be associated with various options that allow the user to designate certain preferences or settings with respect to how certain operating system functions are performed (e.g., display preferences, wireless network preferences, information sharing, accessibility of applications to system information, such as GPS/location, notifications). Once these settings are set, the operating system uses the settings to perform various functions, which includes functions related to execution of handheld picture tag software.

Pictures may include any kind of image data known in the art that is capable of being tagged and processed by smart devices. Image data may be shared between smart devices 1 112, 2 127, and N 142 with the picture tag server 103, the third party database 160, and the social network database may be transmitted through the cloud or Internet 157 using any form of data communication network known in the art. Examples of data communication network or connections that may be used in embodiments of the invention include, yet are not limited to Wi-Fi, cellular, Bluetooth, wireless USB, wireless local area networks, other radio networks, Ethernet, fiber optic, other cable based networks, or telephone lines. In certain instances data communication networks include computer networks, the Internet, TCP/IP networks, a wide area network (WAN), or a local area network (LAN).

Third party database 160 and social network database 163 may include a software module that has the capability of interacting with various third parties and social network members. In addition, third party database 160 and social network database 163 may further provide shared tagged image data to users upon request. For example, a first user may wish to see the tagged image data by their contacts.

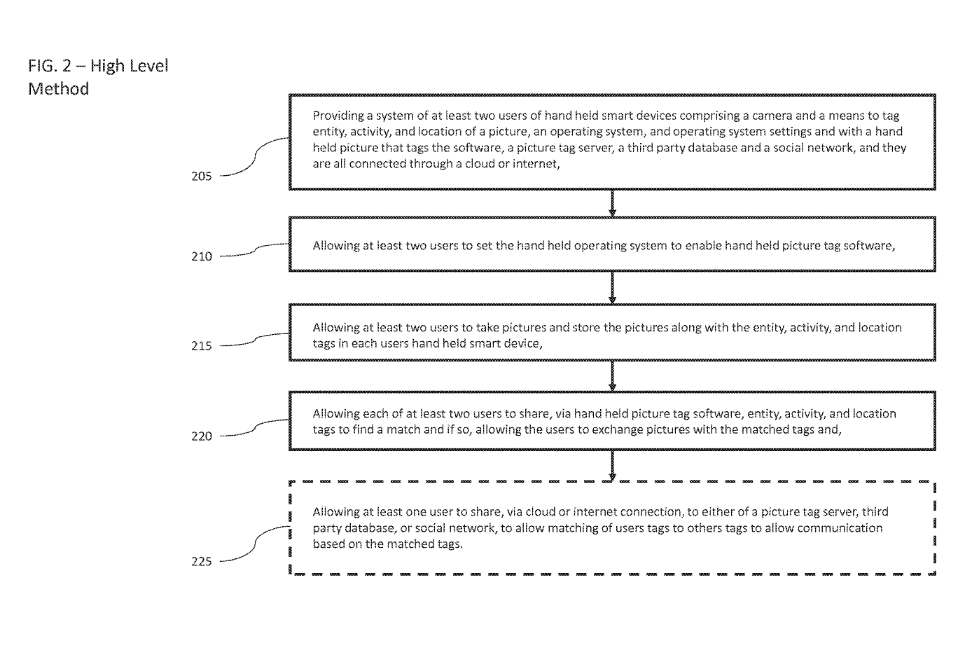

FIG. 2 is a flowchart illustrating an exemplary method for image tagging for sharing. In step 205, at least two users of handheld smart devices may acquire and tag pictures or videos. Each of the smart devices may include cameras, as well as the ability functionality to tag an image with one or more identification tags. The identification tags may include information that uniquely identifies attributes of a photo or video acquired by a smart device. These attributes include, yet are not limited to, an entity name or identifier, an activity, and a location. The images may therefore be tagged and shared with a picture tag server, a third party database, or a social network database according to settings in the user's smart device. In certain instances, one or more of the smart device settings may be implemented in the operating system software of a smart device.

In step 210, users are allowed to set settings in the operating system of their respective handheld devices to enable picture tag software. The users may set various preferences for how they would like to share their photos and videos. For example, a user who wishes to share their photos using social network 163 would set settings in their smart device to enable the sharing of photos with social network 163.

In step 215, the users are allowed to take pictures and store those pictures with their preferred identification tags (e.g., entity, activity, and/or location) relating to each picture on their local smart device.

In step 220, the users are allowed to take, share, and exchange pictures using the identification tags. The users of smart devices may therefore use identification tags when preparing to exchange pictures with other users by matching identification tags. The handheld picture software installed in a user device allows a user's tagged photos or videos to be matched using one or more identification tags (e.g., entity, activity, and/or location). For example, a set of photos from Bob taken while fishing in Florida could be assigned the identification tags: entity=Bob, activity=fishing, and location=Florida.

In certain instances, the identification tags may be assigned by a voice recognition software from a sentence spoken into the smart device. For example, from a spoken sentence “Bob is fishing in Florida,” SIRI voice recognition software could extract Bob, fishing, and Florida and automatically assign identification tags: entity=Bob, activity=fishing, and location=Florida.

In step 225, the users may share photos or videos via the cloud or an Internet connection with the picture tag server 103, the third party database 160, and the social network 163 according to settings on their mobile device. Referring the above example, Bob's picture could therefore be shared with a contact identified in a contact list in Bob's smartphone by sending the photo through the cloud or Internet 157 to the contact's email address.

Another example is where the photo may be tagged with Bob, fishing, and Florida to identify the photo after it has been uploaded and stored to the picture tag server 103, third party database 160, or the social network 163. Individuals who have access to the picture tag server 103, the third party database 160, or the social network 163 could then use keyword matching to search, and download the photo using one or more of keywords Bob, fishing, and Florida. In certain instances, photos of Bob may be uploaded to a public network where an unseen tag allows the entity tag to be seen by anyone accessing the public network.

In certain other instances, advertisers may be allowed see the entity tag by turning on an unseen switch in the third party database which allows any third party to look at it. Advertisers could use information about the entity for developing business models and sending out advertisements. If an advertiser is researching the question of who is fishing in Florida, a picture of Bob fishing in Florida would link to Bob. The advertiser could then send advertisements to Bob.

In addition, family contacts may also be provided with access to the location tag matched to the entity. The family member would not just have the picture associated with the entity, but the location information as well. This would allow a family member to have a filter turned on where they could say, “I′d like to see pictures of the family, but I would like to see them when they are traveling to Florida.” iOS settings may be used with a network to have access to a location tag when matched to the entity. Public networks can analyze location data to figure out where people are traveling to, so they can conduct research for travel agencies to see where people travel.

Furthermore, iOS settings may allow a third party to have access to the location tag when matched to the entity. This may be used by a third party interested in information related to where a location where people live so that advertisers could send out information about local stores or where to buy a vehicle. It also allows the third party to determine where people are when they take pictures, because it is assumed that something special is going on when people take pictures.

In addition, settings may be combined with family contacts. These contacts may therefore be allowed access to the activity tag when matched to the entity. Activities could include fishing, boating, playing, or studying. The family member would not just have the picture associated with the entity, but the activity information too. This would allow a family member to have a filter turned on where they could say, “I'd like to see pictures of family, but I would like to see them when they are fishing.”

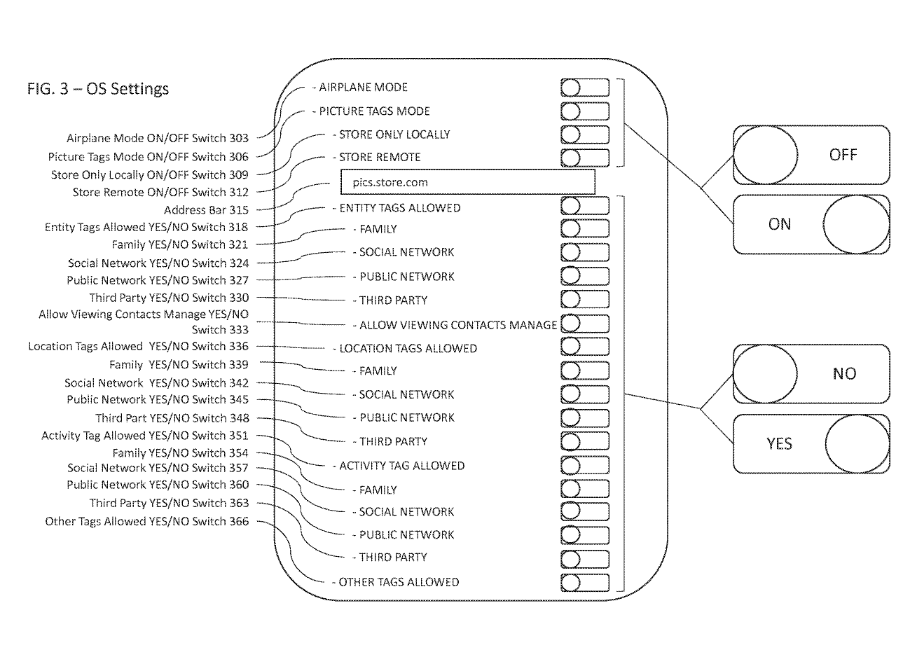

FIG. 3 illustrates exemplary operating system settings of a user device that may be used in a system for image tagging for sharing. Each option may be associated with an on/off button or yes/no buttons that are used to enable or disable various settings on a smartphone. In this instance, the settings may be presented to a user of a smartphone through a graphical user interface of their smartphone. The on/off or yes/no buttons are virtual settings that may be changed using a touchscreen display on a user's smartphone.

Settings may include options for airplane mode 303, picture tags mode 306, entity tags allowed 318, location tags allowed 336, activity tag allowed 351, and other tags allowed 366. Under the picture tags mode 306 are sub-options for store only locally 309, store remote 312, and address bar 315. These settings may be used to enable/disable storing photos only locally or to enable/disable storing photos remotely. Address bar 315 may be a remote address identifying where photos will be stored remotely when the store remote 312 is on (enabled).

Under the entity tags allowed 318 are sub-options for family 321, social network 324, the public network 327, the third party 330, and allowing viewing contacts manage 333. These settings identify locations where photos from the user device may be shared. When each respective switch is enabled (yes), photos may be shared with family, with a public network, and/or with a third party. Depending on a user's preference, a user can share their photos or videos using an entity tag with any or all of these remote resources. Allowing viewing contacts manage 333 enables (yes) or disables (no) photos using entity tags to be shared with contacts in a contact list.

Under the location tags allowed 336 are sub-options for family 339, social network 342, the public network 345, and the third party 348. When each respective switch is enabled (yes), photos may be shared with family, with a public network, and/or with a third party. Depending on a user's preference, a user can share their photos or videos using an entity tag with any or all of these remote resources.

Under the activity tags allowed 351 are sub-options for family 354, social network 357, the public network 360, and the third party 363. When each respective switch is enabled (yes), photos may be shared with family, with a public network, and/or with a third party. Depending on a user's preference, a user can share their photos or videos using an entity tag with any or all of these remote resources. Other tags allowed 336 allows a user to define their own identification tags.

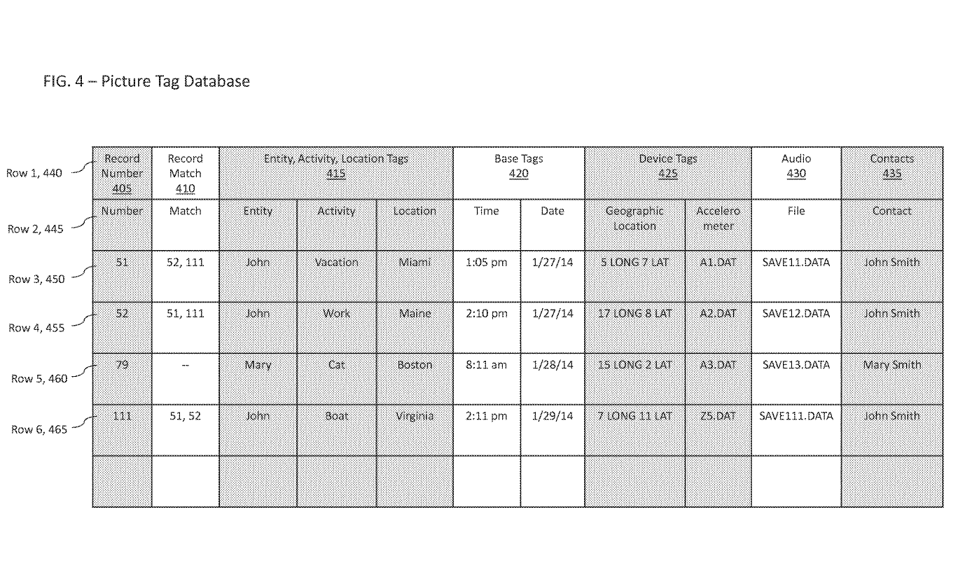

FIG. 4 illustrates an exemplary database that may be used in a system for image tagging for sharing. The columns include record number 405, record match 410, entity; activity; location tags 415, base tags 420, device tabs 425, audio 430, and contacts 435. Rows identified in the matrix include row 1 440, row 2 445, row 3 450, row 4 455, row 5 460, and row 6 465.

Row 1 440 identifies the type of information being tracked. Row 2 445 provides more specific descriptions, such as number, match, entity, activity, location, time date, geographic location, accelerometer, file, and contact.

Row 3 450, row 4 455, row 5 460, and row 6 465 include data entries each of the information fields: record numbers 405, record matches 410, entity; activity; location tags 415, base tags 420, device tabs 425, audio 430, and contacts 435. For example, row 6, 465 includes record number 111, record match 5⅕2, entity/activity/location tags (entity John, activity boat, location Virginia), base tags (time 2:11 PM, date Jan. 29, 14), device tags (geographic location 7 Long 11 Lat, accelerometer Z5.DAT), audio file save111.data, and contact John Smith. As illustrated, record match field 410 associated with row 5 460 is blank, indicating that no record has been matched to record number 79. The matrix therefore correlates associations that connect a stored image by record number, match, entity, activity, location, time date, geographic location, accelerometer, file, and contact that may be used when matching photos of interest.

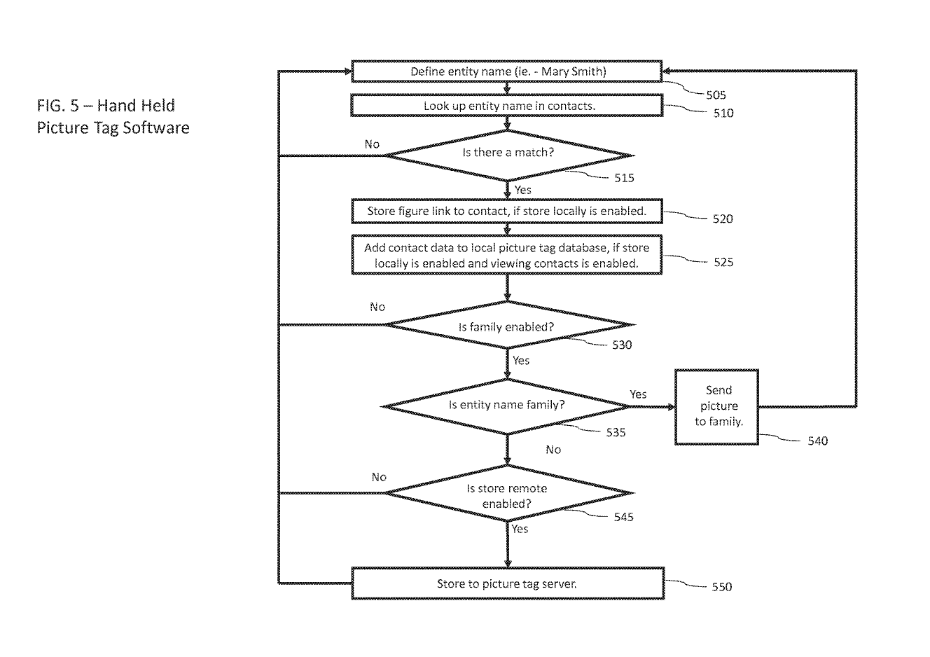

FIG. 5 is a flowchart illustrating another exemplary method for image tagging for sharing. In step 505, an entity name may be defined (e.g., Mary Smith). As such, an entity may be associated with an acquired picture. The entity name may be manually entered or may be automatically entered using voice recognition software (e.g., SIRI).

In step 510, an entity name may be looked up in contacts. Handheld picture tag software may look at contact names associated with Mary Smith. In step 515, it may be determined whether entity Mary Smith includes a contact matched to entity Mary Smith. When there is no match at step 515, the method returns to step 505.

When entity Mary Smith is matched to a contact, a link to a picture identifying that match is stored locally at step 520. In step 525, the matched contact may be added to a local picture tag database. A picture tag database stored locally on a user device may map entities to matched contacts. The local picture tag database allows a user of a smart device to select an entity, see contacts that are matched to that entity, and allow the user to select a contact and see photos that are matched to that contact.

In step 530, the handheld picture tag software may query system settings to see if family is enabled. If yes, the method flows to step 535 where it is determined whether the entire family is enabled. When the entire family is enabled, the method proceeds to step 540 where the picture is sent to the entire family. The method then returns to step 505.

When the entire family is not selected, the method proceeds to step 545 where it is determined whether store remote is enabled. If yes, the method proceeds to step 550 where the pictures are stored on the picture tag server. In certain instances, the picture tag server may then share the picture with some of the family (not shown). From step 550, the method returns to step 505. Alternatively, when remote store in step 545 is not enabled, the method also returns to step 505.

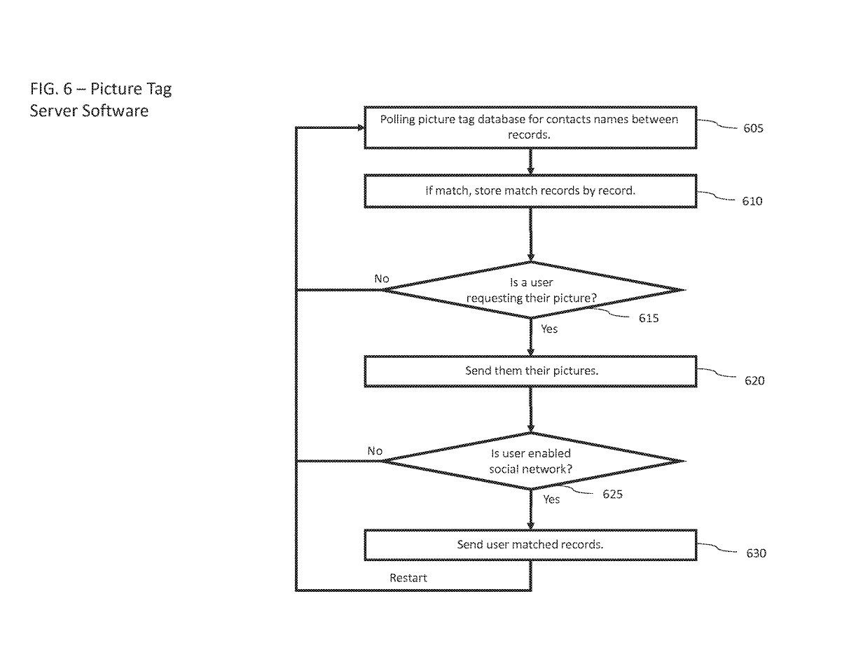

FIG. 6 is a flowchart illustrating yet another exemplary method for image tagging for sharing. In step 605, a picture tag database is polled for contact names and records. In step 610, contact names are matched with records in the picture tag database. In step 615, it may be determined whether the user is requesting their pictures. If no, the method returns to step 605 where polling for contact names and records continues. If yes, the method proceeds to step 620 where pictures from matched records are sent to the user that requested the matched records.

In step 625, it may be determined whether a social network is enabled. Ifno, the method returns to step 605 for additional polling. If yes, the method proceeds to step 630 where matched records are sent to matched users of the social network. The method may then return to step 605 for further polling.

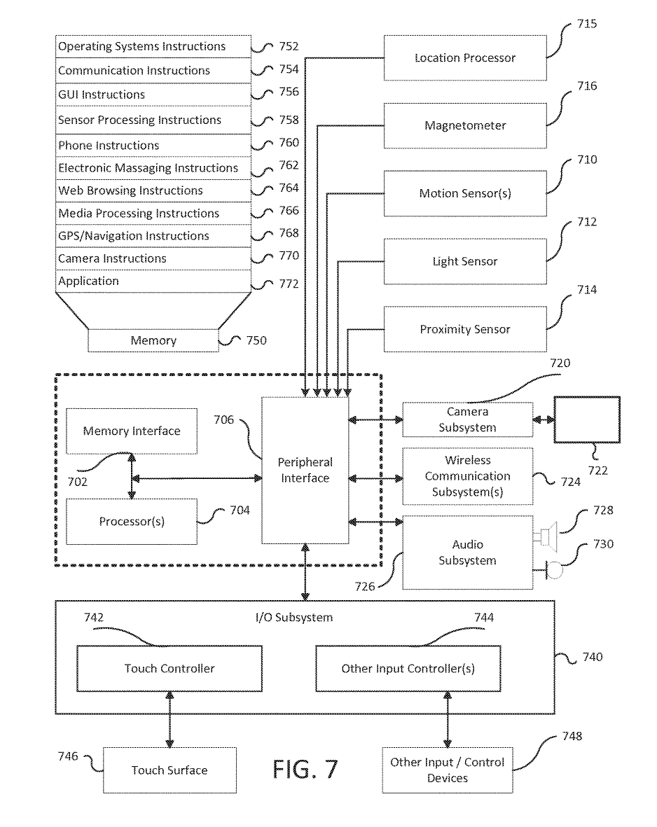

FIG. 7 illustrates a mobile device architecture that may be utilized to implement the various features and processes described herein. Architecture 700 can be implemented in any number of portable devices including but not limited to smart phones, electronic tablets, and gaming devices. Architecture 700 as illustrated in FIG. 7 includes memory interface 702, processors 704, and peripheral interface 706. Memory interface 702, processors 704 and peripherals interface 706 can be separate components or can be integrated as a part of one or more integrated circuits. The various components can be coupled by one or more communication buses or signal lines.

Processors 704 as illustrated in FIG. 7 are meant to be inclusive of data processors, image processors, central processing unit, or any variety of multi-core processing devices. Any variety of sensors, external devices, and external subsystems can be coupled to peripherals interface 706 to facilitate any number of functionalities within the architecture 700 of the exemplar mobile device. For example, motion sensor 710, light sensor 712, and proximity sensor 714 can be coupled to peripherals interface 706 to facilitate orientation, lighting, and proximity functions of the mobile device. For example, light sensor 712 could be utilized to facilitate adjusting the brightness of touch surface 746. Motion sensor 710, which could be exemplified in the context of an accelerometer or gyroscope, could be utilized to detect movement and orientation of the mobile device. Display objects or media could then be presented according to a detected orientation (e.g., portrait or landscape).

Other sensors could be coupled to peripherals interface 706, such as a temperature sensor, a biometric sensor, or other sensing device to facilitate corresponding functionalities. Location processor 715 (e.g., a global positioning transceiver) can be coupled to peripherals interface 706 to allow for generation of geo-location data thereby facilitating geo-positioning. An electronic magnetometer 716 such as an integrated circuit chip could in turn be connected to peripherals interface 706 to provide data related to the direction of true magnetic North whereby the mobile device could enjoy compass or directional functionality. Camera subsystem 720 and an optical sensor 722 such as a charged coupled device (CCD) or a complementary metal-oxide semiconductor (CMOS) optical sensor can facilitate camera functions such as recording photographs and video clips.

Communication functionality can be facilitated through one or more communication subsystems 724, which may include one or more wireless communication subsystems. Wireless communication subsystems 724 can include 802.5 or Bluetooth transceivers as well as optical transceivers such as infrared. Wired communication system can include a port device such as a Universal Serial Bus (USB) port or some other wired port connection that can be used to establish a wired coupling to other computing devices such as network access devices, personal computers, printers, displays, or other processing devices capable of receiving or transmitting data. The specific design and implementation of communication subsystem 724 may depend on the communication network or medium over which the device is intended to operate. For example, a device may include wireless communication subsystem designed to operate over a global system for mobile communications (GSM) network, a GPRS network, an enhanced data GSM environment (EDGE) network, 802.5 communication networks, code division multiple access (CDMA) networks, or Bluetooth networks. Communication subsystem 724 may include hosting protocols such that the device may be configured as a base station for other wireless devices. Communication subsystems can also allow the device to synchronize with a host device using one or more protocols such as TCP/IP, HTTP, or UDP.

Audio subsystem 726 can be coupled to a speaker 728 and one or more microphones 730 to facilitate voice-enabled functions. These functions might include voice recognition, voice replication, or digital recording. Audio subsystem 726 in conjunction may also encompass traditional telephony functions.

I/O subsystem 740 may include touch controller 742 and/or other input controller(s) 744. Touch controller 742 can be coupled to a touch surface 746. Touch surface 746 and touch controller 742 may detect contact and movement or break thereof using any of a number of touch sensitivity technologies, including but not limited to capacitive, resistive, infrared, or surface acoustic wave technologies. Other proximity sensor arrays or elements for determining one or more points of contact with touch surface 746 may likewise be utilized. In one implementation, touch surface 746 can display virtual or soft buttons and a virtual keyboard, which can be used as an input/output device by the user.

Other input controllers 744 can be coupled to other input/control devices 748 such as one or more buttons, rocker switches, thumb-wheels, infrared ports, USB ports, and/or a pointer device such as a stylus. The one or more buttons (not shown) can include an up/down button for volume control of speaker 728 and/or microphone 730. In some implementations, device 700 can include the functionality of an audio and/or video playback or recording device and may include a pin connector for tethering to other devices.

Memory interface 702 can be coupled to memory 750. Memory 750 can include high-speed random access memory or non-volatile memory such as magnetic disk storage devices, optical storage devices, or flash memory. Memory 750 can store operating system 752, such as Darwin, RTXC, LINUX, UNIX, OS X, ANDROID, WINDOWS, or an embedded operating system such as VXWorks. Operating system 752 may include instructions for handling basic system services and for performing hardware dependent tasks. In some implementations, operating system 752 can include a kernel.

Memory 750 may also store communication instructions 754 to facilitate communicating with other mobile computing devices or servers. Communication instructions 754 can also be used to select an operational mode or communication medium for use by the device based on a geographic location, which could be obtained by the GPS/Navigation instructions 768. Memory 750 may include graphical user interface instructions 756 to facilitate graphic user interface processing such as the generation of an interface; sensor processing instructions 758 to facilitate sensor-related processing and functions; phone instructions 760 to facilitate phone-related processes and functions; electronic messaging instructions 762 to facilitate electronic-messaging related processes and functions; web browsing instructions 764 to facilitate web browsing-related processes and functions; media processing instructions 766 to facilitate media processing-related processes and functions; GPS/Navigation instructions 768 to facilitate GPS and navigation-related processes, camera instructions 770 to facilitate camera-related processes and functions; and instructions 772 for any other application that may be operating on or in conjunction with the mobile computing device. Memory 750 may also store other software instructions for facilitating other processes, features and applications, such as applications related to navigation, social networking, location-based services or map displays.

Each of the above identified instructions and applications can correspond to a set of instructions for performing one or more functions described above. These instructions need not be implemented as separate software programs, procedures, or modules. Memory 750 can include additional or fewer instructions. Furthermore, various functions of the mobile device may be implemented in hardware and/or in software, including in one or more signal processing and/or application specific integrated circuits.

Certain features may be implemented in a computer system that includes a back-end component, such as a data server, that includes a middleware component, such as an application server or an Internet server, or that includes a front-end component, such as a client computer having a graphical user interface or an Internet browser, or any combination of the foregoing. The components of the system can be connected by any form or medium of digital data communication such as a communication network. Some examples of communication networks include LAN, WAN and the computers and networks forming the Internet. The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an API that can define on or more parameters that are passed between a calling application and other software code such as an operating system, library routine, function that provides a service, that provides data, or that performs an operation or a computation. The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer may employ to access functions supporting the API. In some implementations, an API call can report to an application the capabilities of a device running the application, such as input capability, output capability, processing capability, power capability, and communications capability.

Users may use any number of different electronic user devices, such as general purpose computers, mobile phones, smartphones, personal digital assistants (PDAs), portable computing devices (e.g., laptop, netbook, tablets), desktop computing devices, handheld computing device, or any other type of computing device capable of communicating over communication network. User devices may also be configured to access data from other storage media, such as memory cards or disk drives as may be appropriate in the case of downloaded services. User device may include standard hardware computing components such as network and media interfaces, non-transitory computer-readable storage (memory), and processors for executing instructions that may be stored in memory.

Communication network allow for communication between the user device, cloud social media system, and third party developers via various communication paths or channels. Such paths or channels may include any type of data communication link known in the art, including TCP/IP connections and Internet connections via Wi-Fi, Bluetooth, UMTS, etc. In that regard, communications network may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider.

Communications network allows for communication between any of the various components of network environment may include any type of server or other computing device as is known in the art, including standard hardware computing components such as network and media interfaces, non-transitory computer-readable storage (memory), and processors for executing instructions or accessing information that may be stored in memory. The functionalities of multiple servers may be integrated into a single server. Alternatively, different functionalities may be allocated among multiple servers, which may be located remotely from each other and communicate over the cloud. Any of the aforementioned servers (or an integrated server) may take on certain client-side, cache, or proxy server characteristics. These characteristics may depend on the particular network placement of the server or certain configurations of the server.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

1. (canceled)

2. A method for organizing access to one or more tagged images, the method comprising:
receiving one or more images sent by a user device over a communication network to a first server in accordance with one or more settings of the user device, wherein the one or more settings identify which of a plurality of different servers are to be sent the one or more images and at least one contact to be sent a copy of at least one of the one or more images;
storing the at least one image in a database in memory, wherein the at least one image of the one or more images is stored in association with an entity, at least one image tag, and at least one contact;
sharing the at least one image based on at least one of the one or more settings, wherein a copy of the at least one image is provided to the at least one contact based on the one or more settings, the entity, and the at least one image tag; and
sending the at least one image of the one or more images stored in the database to a second server based on the one or more settings set at the user device, wherein the second server performs a function on the at least one image in accordance with the one or more settings.

3. The method of claim 2, wherein a first setting of the one or more settings identifies that image data is to be shared with the first server and a second setting of the one or more settings identifies that the image data is to be shared with the second server.

4. The method of claim 2, wherein the at least one setting of the one or more settings is an operating system setting that corresponds to an operating system function of sending the one or more images to the first server over the communication network.

5. The method of claim 2, wherein sharing the at least one image comprises sending the copy of the at least one image to the at least one contact.

6. The method of claim 2, further comprising identifying that the at least one image is to be sent to an advertiser based on the one or more settings, wherein the user device is sent an advertisement based on the one or more settings that allow the advertiser to send the advertisement to the user device.

7. The method of claim 2, wherein sharing the at least one image comprises sending the at least one image to a member of a social network based on the one or more settings.

8. The method of claim 2, wherein the at least one image tag identifies a location.

9. A non-transitory computer readable storage medium having embodied thereon a program executable by a processor for implementing a method for organizing access to one or more tagged images, the method comprising:
receiving one or more images sent by a user device over a communication network to a first server in accordance with one or more settings of the user device, wherein the one or more settings identify which of a plurality of different servers are to be sent the one or more images and at least one contact to be sent a copy of at least one of the one or more images;
storing the at least one image in a database in memory, wherein the at least one image of the one or more images is stored in association with an entity, at least one image tag, and at least one contact;
sharing the at least one image based on at least one of the one or more settings, wherein a copy of the at least one image is provided to the at least one contact based on the one or more settings, the entity, and the at least one image tag; and
sending the at least one image of the one or more images stored in the database to a second server based on the one or more settings set at the user device, wherein the second server performs a function on the at least one image in accordance with the one or more settings.

10. The non-transitory computer readable storage medium of claim 9, wherein a first setting of the one or more settings identifies that image data is to be shared with the first server and a second setting of the one or more settings identifies that the image data is to be shared with the second server.

11. The non-transitory computer readable storage medium of claim 9, wherein the at least one setting of the one or more settings is an operating system setting that corresponds to an operating system function of sending the one or more images to the first server over the communication network.

12. The non-transitory computer readable storage medium of claim 9, wherein sharing the at least one image comprises sending the copy of the at least one image to the at least one contact.

13. The non-transitory computer readable storage medium of claim 9, wherein the program further comprises instructions executable to identify that the at least one image is to be sent to an advertiser based on the one or more settings, wherein the user device is sent an advertisement based on the one or more settings that allow the advertiser to send the advertisement to the user device.

14. The non-transitory computer readable storage medium of claim 9, wherein sharing the at least one image comprises sending the at least one image to a member of a social network based on the one or more settings.

16. The non-transitory computer readable storage medium of claim 9, wherein the at least one image tag identifies a location.

17. A server apparatus for organizing access to one or more tagged images, the server apparatus comprising:
a communication interface that receives one or more images sent by a user device over a communication network in accordance with one or more settings of the user device, wherein the one or more settings identify which of a plurality of different servers are to be sent the one or more images and at least one contact to be sent a copy of at least one of the one or more images; and
memory that stores the at least one image in a database, wherein the at least one image of the one or more images is stored in association with an entity, at least one image tag, and at least one contact;
wherein the communication interface:
shares the at least one image based on at least one of the one or more settings, wherein a copy of the at least one image is provided to the at least one contact based on the one or more settings, the entity, and the at least one image tag; and
sends the at least one image of the one or more images stored in the database to a second server based on the one or more settings set at the user device, wherein the second server performs a function on the at least one image in accordance with the one or more settings.

18. The apparatus of claim 17, wherein a first setting of the one or more settings identifies that image data is to be shared with the first server and a second setting of the one or more settings identifies that the image data is to be shared with the second server.

19. The method of claim 17, wherein the at least one setting of the one or more settings is an operating system setting that corresponds to an operating system function of sending the one or more images to the first server over the communication network.

20. The method of claim 17, wherein the communication interface shares the at least one image by sending the copy of the at least one image to the at least one contact.

21. The method of claim 17, wherein that the at least one image is to be sent to an advertiser based on the one or more settings and the user device is sent an advertisement based on the one or more settings that allow the advertiser to send the advertisement to the user device.
